(19) United States
(12) Patent Application Publication
(10) Pub. No.: US 2026/0035010 A1
(43) Pub. Date: Feb. 5, 2026

(54) Vehicle Control Apparatus and Method Thereof

(71) Applicants: Hyundai Motor Company, Seoul (KR); Kia Corporation, Seoul (KR)

(72) Inventor: Su Rin Jo, Hwaseong-Si (KR)

(21) Appl. No.: 19/062,347

(22) Filed: Feb. 25, 2025

(30) Foreign Application Priority Data
Aug. 2, 2024 (KR) 10-2024-0103379

(51) Int. Cl. B60W 60/00

(52) U.S. Cl. CPC B60W 60/001; B60W 2554/4041

(57) ABSTRACT

An apparatus for controlling driving of a vehicle is introduced. The apparatus may comprise a memory storing at least one instruction and a processor operatively coupled with the memory. The at least one instruction, when executed by the processor, is configured to cause the apparatus to obtain a dataset comprising a plurality of frames for driving control of the vehicle, classify the dataset into a plurality of bundles, and divide the plurality of bundles into training data and evaluation data. Based on the training data and the evaluation data satisfying a first condition, an accuracy test is performed. Based on the accuracy test satisfying a second condition, an artificial intelligence model is trained or its performance is evaluated. The apparatus may output a signal based on the trained artificial intelligence model or the evaluated performance of the artificial intelligence model and control, based on the signal, driving of the vehicle.

### CROSS-REFERENCE TO RELATED APPLICATION

This application claims the benefit of priority to Korean Patent Application No. 10-2024-0103379, filed in the Korean Intellectual Property Office on Aug. 2, 2024, the entire contents of which are incorporated herein by reference.

### TECHNICAL FIELD

The present disclosure relates to a vehicle control apparatus and a method thereof, and more particularly, relates to technologies for classifying a dataset for driving control of a vehicle.

### BACKGROUND

The matters described in this Background section are only for the enhancement of understanding of the background of the disclosure, and should not be taken as acknowledgment that they correspond to prior art already known to those skilled in the art.

As an autonomous driving control technology and/or a semi-autonomous driving control (or cruise driving) technology are/is developed, a stable driving technology for a host vehicle may gradually become more sophisticated. For example, if identifying a situation in which there is a use for deceleration driving, biased driving, or a lane change while performing driving control for the host vehicle, there is a use to develop various algorithms for performing a driving strategy determined according to various conditions of the identified situation.

Meanwhile, the processing of sensor data obtained by means of a sensor may be accurately and quickly performed for autonomous driving control. Particularly, there is a use to develop technologies for detecting and identifying a surrounding environment (e.g., an external object) around the host vehicle, by means of various artificial intelligence models (e.g., deep learning models) for processing sensor data.

In addition, data may be classified into two, if using the artificial intelligence model. For example, training data for training the artificial intelligence model and evaluation data for evaluation may be data divided into two to use the artificial intelligence model.

However, if the dataset is simply divided at a predetermined ratio, specific parameters are concentrated in only some pieces of data and accuracy is reduced. Thus, there is a use to provide adaptive criteria for dividing a dataset into evaluation data and training data.

### SUMMARY

According to the present disclosure, an apparatus for controlling driving of a vehicle, the apparatus may comprise a memory storing at least one instruction, and a processor operatively coupled with the memory, wherein the at least one instruction, when executed by the processor, is configured to cause the apparatus to obtain a dataset comprising a plurality of frames for driving control of the vehicle, classify the dataset into a plurality of bundles, divide the plurality of bundles into training data and evaluation data, based on the training data and the evaluation data satisfying a first condition, perform an accuracy test for the training data and the evaluation data, based on the accuracy test satisfying a second condition, train an artificial intelligence model or evaluate performance of the artificial intelligence model, output a signal, based on the trained artificial intelligence model or the evaluated performance of the artificial intelligence model, and control, based on the signal, driving of the vehicle.

The apparatus may further comprise a sensor, wherein the at least one instruction, when executed by the processor, is configured to cause the apparatus to input sensor data obtained using the sensor to the artificial intelligence model to detect an object which is present outside the vehicle during the driving control.

The plurality of frames may comprise at least one of a class of an external object, a location of the external object, a dimension of the external object, an acquisition period, wherein the acquisition period corresponds to a duration of time over which data is collected for frames within a bundle, surrounding traffic environment information, global positioning system (GPS) information, or weather information.

The at least one instruction, when executed by the processor, is configured to cause the apparatus to identify a first number of specified objects included in first frames, wherein the first frames are within a first bundle of the plurality of bundles divided into the training data, identify a second number of the specified objects included in second frames, wherein the second frames are within a second bundle of the plurality of bundles divided into the evaluation data, and determine that the first condition is satisfied based on a ratio between the first number and the second number being within a specified error range from a predefined ratio.

The at least one instruction, when executed by the processor, is configured to cause the apparatus to obtain the plurality of frames using the sensor, and classify, based on an acquisition time of each of the plurality of frames, the dataset into the plurality of bundles.

The at least one instruction, when executed by the processor, is configured to cause the apparatus to, based on the first condition not being satisfied, reduce a criteria time for classifying the dataset into the plurality of bundles and classify the dataset into the plurality of bundles again.

The at least one instruction, when executed by the processor, is configured to cause the apparatus to identify a plurality of division results of dividing the plurality of bundles into the training data and the evaluation data, and based on each of the plurality of division results not satisfying the first condition, classify the dataset into a different plurality of bundles again.

The at least one instruction, when executed by the processor, is configured to cause the apparatus to, based on a difference between a first inclusion percentage and a second inclusion percentage being less than or equal to a specified percentage, determine that the second condition is satisfied, wherein the first inclusion percentage corresponds to a proportion of first frames that include each of external objects, wherein the first frames are within a first bundle of the plurality of bundles divided into the training data, and the second inclusion percentage corresponds to a proportion of second frames that include each of the external objects, wherein the second frames are within a second bundle of the plurality of bundles divided into evaluation data.

The at least one instruction, when executed by the processor, is configured to cause the apparatus to, based on a difference between a first standard deviation and a second standard deviation being less than or equal to a specified value, determine that the second condition is satisfied, wherein the first standard deviation corresponds to a standard deviation of a probability distribution for each of the external objects included in the first frames, and the second standard deviation corresponds to a standard deviation of a probability distribution for each of the external objects included in the second frames.

The at least one instruction, when executed by the processor, is configured to cause the apparatus to determine whether the second condition is satisfied, further based on at least one of weather information of each of the training data and the evaluation data, traffic congestion of each of the training data and the evaluation data, global positioning system (GPS) information of each of the training data and the evaluation data, or a number of vehicles per frame of each of the training data and the evaluation data.

According to the present disclosure, a method performed by an apparatus for controlling driving of a vehicle, the method may comprise obtaining a dataset comprising a plurality of frames for driving control of the vehicle, classifying the dataset into a plurality of bundles, dividing the plurality of bundles into training data and evaluation data, based on the training data and the evaluation data satisfying a first condition, performing an accuracy test for the training data and the evaluation data, based on the accuracy test satisfying a second condition, training an artificial intelligence model or evaluating performance of the artificial intelligence model, outputting a signal, based on the trained artificial intelligence model or the evaluated performance of the artificial intelligence model, and controlling, based on the signal, driving of the vehicle.

The method may further comprise inputting sensor data obtained using a sensor of the vehicle to the artificial intelligence model to detect an object which is present outside the vehicle during the driving control.

The plurality of frames may comprise at least one of a class of an external object, a location of the external object, a dimension of the external object, an acquisition period, wherein the acquisition period corresponds to a duration of time over which data is collected for frames within a bundle, surrounding traffic environment information, global positioning system (GPS) information, or weather information.

The method may further comprise identifying a first number of specified objects included in first frames, wherein the first frames are within a first bundle of the plurality of bundles divided into the training data, identifying a second number of the specified objects included in second frames, wherein the second frames are within a second bundle of the plurality of bundles divided into the evaluation data, and determining that the first condition is satisfied based on a ratio between the first number and the second number being within a specified error range from a predefined ratio.

The method may further comprise obtaining the plurality of frames using the sensor, and classifying, based on an acquisition time of each of the plurality of frames, the dataset into the plurality of bundles.

The method may further comprise, based on the first condition not being satisfied, reducing a criteria time for classifying the dataset into the plurality of bundles and classifying the dataset into the plurality of bundles again.

The method may further comprise identifying a plurality of division results of dividing the plurality of bundles into the training data and the evaluation data, and based on each of the plurality of division results not satisfying the first condition, classifying the dataset into a different plurality of bundles again.

The method may further comprise, based on a difference between a first inclusion percentage and a second inclusion percentage being less than or equal to a specified percentage, determining that the second condition is satisfied, wherein the first inclusion percentage corresponds to a proportion of first frames that include each of external objects, wherein the first frames are within a first bundle of the plurality of bundles divided into the training data, and the second inclusion percentage corresponds to a proportion of second frames that include each of the external objects, wherein the second frames are within a second bundle of the plurality of bundles divided into evaluation data.

The method may further comprise, based on a difference between a first standard deviation and a second standard deviation being less than or equal to a specified value, determining that the second condition is satisfied, wherein the first standard deviation corresponds to a standard deviation of a probability distribution for each of the external objects included in the first frames, and the second standard deviation corresponds to a standard deviation of probability distribution for each of the external objects included in the second frames.

The method may further comprise determining whether the second condition is satisfied, further based on at least one of weather information of each of the training data and the evaluation data, traffic congestion of each of the training data and the evaluation data, global positioning system (GPS) information of each of the training data and the evaluation data, or a number of vehicles per frame of each of the training data and the evaluation data.

### BRIEF DESCRIPTION OF THE DRAWINGS

The above and other objects, features and advantages of the present disclosure will be more apparent from the following detailed description taken in conjunction with the accompanying drawings:

FIG. 1 shows an example of components of a vehicle control apparatus according to an example of the present disclosure;

FIG. 2 shows an example of the result of classifying a plurality of frames into a plurality of bundles in a vehicle control apparatus according to an example of the present disclosure;

FIG. 3 shows an example of the result of dividing a plurality of bundles into training data or evaluation data in a vehicle control apparatus according to an example of the present disclosure;

FIG. 4 shows an example of a plurality of division results of dividing a plurality of bundles in a vehicle control apparatus according to an example of the present disclosure;

FIG. 5 shows an example of the number of objects included in training data and evaluation data according to an example of the present disclosure;

FIG. 6A shows an example of a specific object included in training data and evaluation data in a specified technique according to an example of the present disclosure;

FIG. 6B shows an example of a specific object included in training data and evaluation data in a specified technique according to an example of the present disclosure;

FIG. 6C shows an example of a specific object included in training data and evaluation data in a specified technique according to an example of the present disclosure;

FIG. 6D shows an example of a specific object included in training data and evaluation data in a specified technique according to an example of the present disclosure;

FIG. 7 shows an example of a vehicle control method according to an example of the present disclosure; and

FIG. 8 shows an example of a computing system about a vehicle control method according to an example of the present disclosure.

With regard to description of drawings, the same or similar denotations may be used for the same or similar components.

### DETAILED DESCRIPTION

Hereinafter, some examples of the present disclosure will be described in detail with reference to the exemplary drawings. In adding the reference numerals to the components of each drawing, it should be noted that the identical component is designated by the identical numerals even when they are displayed on other drawings. In addition, a detailed description of well-known features or functions will be ruled out in order not to unnecessarily obscure the gist of the present disclosure.

In describing the components of the example of the present disclosure, terms such as first, second, “A”, “B”, (a), (b), and the like may be used. These terms are only used to distinguish one element from another element, but do not limit the corresponding elements irrespective of the order or priority of the corresponding elements. Furthermore, unless otherwise defined, all terms including technical and scientific terms used herein have the same meaning as being generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, and C”, “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

An automation level of an autonomous driving vehicle may be classified as follows, according to the American Society of Automotive Engineers (SAE). At autonomous driving level 0, the SAE classification standard may correspond to “no automation,” in which an autonomous driving system is temporarily involved in emergency situations (e.g., automatic emergency braking) and/or provides warnings only (e.g., blind spot warning, lane departure warning, etc.), and a driver is expected to operate the vehicle. At autonomous driving level 1, the SAE classification standard may correspond to “driver assistance,” in which the system performs some driving functions (e.g., steering, acceleration, brake, lane centering, adaptive cruise control, etc.) while the driver operates the vehicle in a normal operation section, and the driver is expected to determine an operation state and/or timing of the system, perform other driving functions, and cope with (e.g., resolve) emergency situations. At autonomous driving level 2, the SAE classification standard may correspond to “partial automation,” in the system which performs steering, acceleration, and/or braking under the supervision of the driver, and the driver is expected to determine an operation state and/or timing of the system, perform other driving functions, and cope with (e.g., resolve) emergency situations. At autonomous driving level 3, the SAE classification standard may correspond to “conditional automation,” in which the system drives the vehicle (e.g., performs driving functions such as steering, acceleration, and/or braking) under limited conditions but transfer driving control to the driver if the required conditions are not met, and the driver is expected to determine an operation state and/or timing of the system, and take over control in emergency situations but do not otherwise operate the vehicle (e.g., steer, accelerate, and/or brake). At autonomous driving level 4, the SAE classification standard may correspond to “high automation,” in which the system performs all driving functions, and the driver is expected to take control of the vehicle only in emergency situations. At autonomous driving level 5, the SAE classification standard may correspond to “full automation,” in which the system performs full driving functions without any aid from the driver including in emergency situations, and the driver is not expected to perform any driving functions other than determining the operating state of the system. Although the present disclosure may apply the SAE classification standard for autonomous driving classification, other classification methods and/or algorithms may be used in one or more configurations described herein.

One or more features associated with autonomous driving control may be activated based on configured autonomous driving control setting(s) (e.g., based on at least one of: an autonomous driving classification, a selection of an autonomous driving level for a vehicle, etc.). Based on one or more features (e.g., features of classifying dataset into bundles and dividing the bundles into training data and evaluation data) described herein, an operation of the vehicle may be controlled. The vehicle control may include various operational controls associated with the vehicle (e.g., autonomous driving control, sensor control, braking control, braking time control, acceleration control, acceleration change rate control, alarm timing control, forward collision warning time control, etc.).

One or more auxiliary devices (e.g., engine brake, exhaust brake, hydraulic retarder, electric retarder, regenerative brake, etc.) may also be controlled, for example, based on one or more features (e.g., features of classifying dataset into bundles and dividing the bundles into training data and evaluation data) described herein.

One or more communication devices (e.g., a modem, a network adapter, a radio transceiver, an antenna, etc., that is capable of communicating via one or more wired or wireless communication protocols, such as Ethernet, Wi-Fi, near-field communication (NFC), Bluetooth, Long-Term Evolution (LTE), 5G New Radio (NR), vehicle-to-everything (V2X), etc.) may also be controlled, for example, based on one or more features (e.g., features of classifying dataset into bundles and dividing the bundles into training data and evaluation data) described herein.

Minimum risk maneuver (MRM) operation(s) may also be controlled, for example, based on one or more features (e.g., features of classifying dataset into bundles and dividing the bundles into training data and evaluation data) described herein. A minimal risk maneuvering operation (e.g., a minimal risk maneuver, a minimum risk maneuver) may be a maneuvering operation of a vehicle to minimize (e.g., reduce) a risk of collision with surrounding vehicles in order to reach a lowered (e.g., minimum) risk state. A minimal risk maneuver may be an operation that may be activated during autonomous driving of the vehicle if a driver is unable to respond to a request to intervene. During the minimal risk maneuver, one or more processors of the vehicle may control a driving operation of the vehicle for a set period of time.

Biased driving operation(s) may also be controlled, for example, based on one or more features (e.g., features of classifying dataset into bundles and dividing the bundles into training data and evaluation data) described herein. A driving control apparatus may perform a biased driving control. To perform a biased driving, the driving control apparatus may control the vehicle to drive in a lane by maintaining a lateral distance between the position of the center of the vehicle and the center of the lane. For example, the driving control apparatus may control the vehicle to stay in the lane but not in the center of the lane. The driving control apparatus may identify or determine a biased target lateral distance for biased driving control. For example, a biased target lateral distance comprise an intentionally adjusted lateral distance that a vehicle may aim to maintain from a reference point, such as the center of a lane or another vehicle, during maneuvers such as lane changes. This adjustment may be made to improve the vehicle's stability, safety, and/or performance under varying driving conditions, etc. For example, during a lane change, the driving control system may bias the lateral distance to keep a safer gap from adjacent vehicles, considering factors such as the vehicle's speed, road conditions, and/or the presence of obstacles, etc.

One or more sensors (e.g., IMU sensors, camera, LIDAR, RADAR, blind spot monitoring sensor, line departure warning sensor, parking sensor, light sensor, rain sensor, traction control sensor, anti-lock braking system sensor, tire pressure monitoring sensor, seatbelt sensor, airbag sensor, fuel sensor, emission sensor, throttle position sensor, inverter, converter, motor controller, power distribution unit, high-voltage wiring and connectors, auxiliary power modules, charging interface, etc.) may also be controlled, for example, based on one or more features (e.g., features of classifying dataset into bundles and dividing the bundles into training data and evaluation data) described herein. An operation control for autonomous driving of the vehicle may include various driving control of the vehicle by the vehicle control device (e.g., acceleration, deceleration, steering control, gear shifting control, braking system control, traction control, stability control, cruise control, lane keeping assist control, collision avoidance system control, emergency brake assistance control, traffic sign recognition control, adaptive headlight control, etc.).

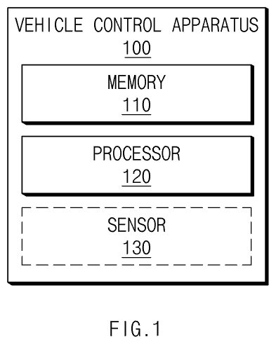

Hereinafter, examples of the present disclosure will be described in detail with reference to FIGS. 1 to 8.

FIG. 1 shows an example of components of a vehicle control apparatus according to an example of the present disclosure.

According to an example, a vehicle control apparatus 100 may include at least one of a memory 110, a processor 120, or a sensor 130, or any combination thereof. The components of the vehicle control apparatus 100, which are shown in FIG. 1, are illustrative, and examples of the present disclosure are not limited thereto. For example, the vehicle control apparatus 100 may further include components (e.g., at least one of an interface, a communication device, a display, or a driving device, or any combination thereof) which are not shown in FIG. 1.

According to an example, the memory 110 may store a command or data. For example, the memory 110 may store one or more instructions, when executed by the processor 120, causing the vehicle control apparatus 100 to perform various operations.

For example, the memory 110 and the processor 120 may be implemented as one chipset. The processor 120 may include at least one of a communication processor or a modem.

For example, the memory 110 may store an operation history of the vehicle control apparatus 100. For example, the memory 110 may store a dataset obtained by means of the sensor 130. For example, the memory 110 may store the result of being divided into training data and evaluation data under control of the processor 120. Training data may be a portion of a dataset used to train machine learning models by enabling them to learn patterns and relationships. Evaluation data may be used to test the model's performance on unseen data to ensure the model may generalize effectively. Training data and evaluation data may be distinct, with no overlap, to avoid overfitting and ensure reliable evaluation metrics. Both training and evaluation data may have balanced and similar distributions, reflecting the overall dataset, to prevent biases or skewed results. To achieve the balanced and similar distributions, the dataset may be divided in a deliberate way (e.g., ensuring rare object types or specific environmental conditions are present in both subsets in comparable proportions) or a systematic way (e.g., avoiding imbalances or unintended biases that may arise from simple random splitting) to ensure both subsets are distinct (e.g., no overlap between the training data and evaluation data to avoid overfitting), balanced (e.g., both subsets having similar distribution key features such as object classes, environment conditions, or acquisition settings, etc.), and representative (e.g., each subset accurately reflecting the diversity of the overall dataset, covering a wide range of cases to prevent biases).

According to an example, the processor 120 may be operatively connected with the memory 110 and/or the sensor 130. For example, the processor 120 may control operations of the memory 110 and/or the sensor 130.

For example, the processor 120 may obtain a dataset for driving control for a host vehicle.

As an example, the dataset may include a plurality of frames for driving control for the host vehicle.

As an example, the processor 120 may obtain a dataset using the sensor 130. The plurality of frames included in the dataset may include, for example, various pieces of information about a driving environment of the host vehicle.

As an example, the plurality of frames may include information about an external object (e.g., another vehicle, a person, a thing, a building, a road structure, or the like) (e.g., a class of the other vehicle, a location of the other vehicle, or a dimension of the other vehicle).

As an example, the plurality of frames may include information about at least one of an acquisition period of the frame, a surrounding traffic environment, global positioning system (GPS) information, or weather information (or type), or any combination thereof.

For example, the processor 120 may classify the dataset into a plurality of bundles.

As an example, the processor 120 may classify the plurality of frames included in the dataset into different bundles. For example, the processor 120 may obtain the plurality of frames using the sensor 130 and may classify the dataset into the plurality of bundles based on an acquisition time of each of the plurality of frames.

As an example, the processor 120 may classify first frames obtained during a second time point from a first time point into a first bundle and may classify second frames obtained during a third time point from the second time point into a second bundle. A difference between the first time point and the third time point may be a specified time (e.g., 30 minutes). In other words, the processor 120 may classify a frame obtained after the specified time elapses from an acquisition time of a specific frame as a bundle different from a specific time.

As an example, the processor 120 may adjust the specified time which is bundle classification criteria. For example, if the divided training data and the divided evaluation data do not meet a first condition, the processor 120 may determine whether the first condition is met based on the plurality of bundles which are classified again by reducing the specified time.

For example, the processor 120 may divide the plurality of bundles into training data or evaluation data.

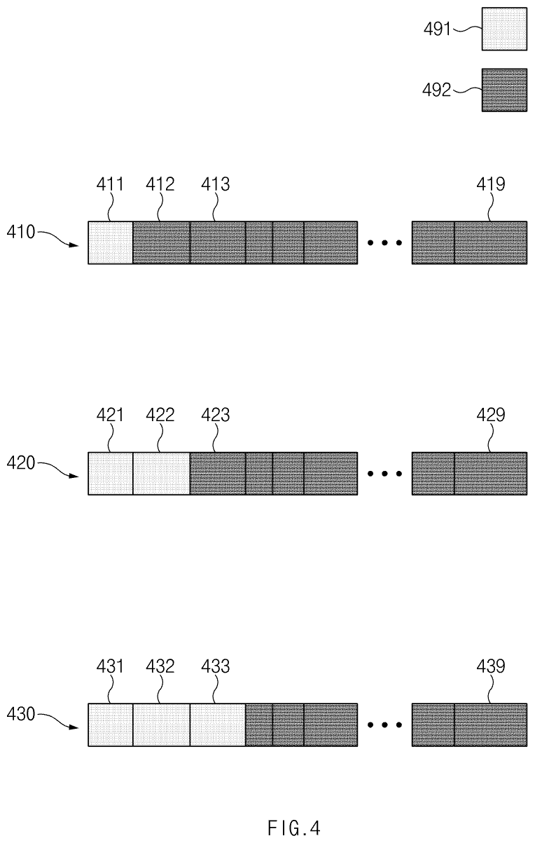

As an example, the processor 120 may identify a plurality of division results of dividing the plurality of bundles into training data and evaluation data. In other words, the processor 120 may determine whether each of the plurality of division results of dividing the plurality of bundles into the training data and the evaluation data meets the first condition. The plurality of division results may be defined as, for example, a description of FIG. 4, which will be described below.

For example, if the training data and the evaluation data meet the first condition, the processor 120 may perform an accuracy test for the training data and the evaluation data.

As an example, the processor 120 may determine whether each of the above-mentioned plurality of division results meets the first condition and may perform an accuracy test for the result of being divided into the training data and the evaluation data, which meet the first condition.

As an example, the processor 120 may determine whether the first condition is met based on the number of specified objects (e.g., vehicles or cars) included in each of the training data and the evaluation data. For example, the processor 120 may identify the first number of specified objects included in the first frames in the first bundle classified into the training data and may identify the second number of the specified objects included in the second frames in the second bundle classified as the evaluation data. Thereafter, if a ratio between the first number and the second number is within a specified error range from a predefined ratio, the processor 120 may determine that the corresponding division result (or the corresponding training data and the corresponding evaluation data) meets the first condition. For example, if the predefined ratio is 7:3, the processor 120 may determine whether the ratio between the first number and the second number is within the specified error range from 7:3. The predefined ratio and/or the specified error range (e.g., 5%) may be setting values changeable by a user and/or a developer.

As an example, the processor 120 may identify a plurality of division results of dividing the plurality of bundles into training data and evaluation data and may classify the dataset into a different plurality of bundles again, if each of the plurality of division results does not meet the first condition. At this time, the processor 120 may adjust (e.g., reduce) criteria (e.g., a difference in acquisition time between frames) for being divided into the plurality of bundles, thus classifying the dataset into the different plurality of bundles.

For example, if the result of performing the accuracy test meets a second condition, the processor 120 may train an artificial intelligence model or may evaluate performance of the artificial intelligence model, based on the training data and the evaluation data.

As an example, if a difference between a first inclusion percentage of each of external objects included in the first frames in the first bundle divided into the training data and a second inclusion percentage of each of the external objects included in the second frames in the second bundle divided into the evaluation data is less than or equal to a specified percentage, the processor 120 may determine that the second condition is met. In other words, if an inclusion percentage of a first object (e.g., a car) among the external objects included in the first frames is 70% compared to all the objects and the inclusion percentage of the first object among the external objects included in the second frames is 65% compared to all the objects, because a difference between the two inclusion percentages is 5%, the processor 120 may determine that the difference between the two inclusion percentages is less than or equal to a specified percentage (e.g., 5%). In this manner, if a difference between percentages of each of other objects (e.g., a van, a truck, a bus, a bicycle, and a person) among the external objects included in the first frames and the second frames is less than or equal to the specified percentage, the processor 120 may determine that the second condition is met.

As an example, if a difference between a first standard deviation of a probability distribution for each of external objects (e.g., a person (or a pedestrian), a car, a truck, a van, and a bus) included in the first frames and a second standard deviation of the probability distribution for each of the external objects included in the second frames is less than or equal to a specified value, the processor 120 may determine that the second condition is met. For example, the processor 120 may calculate the first standard deviation and the second standard deviation of the probability distribution of each of the external objects included in the first frames and the second frames based on a bird's eye view (BEV). For example, if the difference between the first standard deviation and the second standard deviation is less than or equal to the specified value, the processor 120 may determine that the result of dividing the first frames and the second frames is suitable for being applied to the artificial intelligence model. The specified value may be, for example, a setting value changeable by the user and/or the developer.

As an example, the processor 120 may determine whether the second condition is met, based further on criteria information including at least one of weather information of each of the training data and the evaluation data, traffic congestion of each of the training data and the evaluation data, global positioning system (GPS) information of each of the training data and the evaluation data, or the number of vehicles per frame of each of the training data and the evaluation data, or any combination thereof. For example, the processor 120 may determine pieces of unnecessarily duplicated data are concentrated in the training data or the evaluation data, based on the above-mentioned criteria information, and may determine that the second condition is not met, if it is determined that the pieces of data are concentrated. The processor 120 may identify, for example, traffic congestion of each of frames based on the number of vehicles per frame. For example, the processor 120 may calculate traffic congestion based on whether the number of pieces of data labeled as the car in a specific frame is greater than a specified number (e.g., 40) in a specific frame.

For example, if determining whether the above-mentioned second condition is met, the processor 120 may determine a determination order based on a specified priority.

As an example, the processor 120 may determine whether the second condition is met based on a scheme using an inclusion percentage of the external object in a first priority, may determine the second condition is met based on a scheme using a difference between standard deviations of a probability distribution in a second priority, and may determine whether the second condition is met based on a scheme using criteria information in a third priority.

According to an example, the sensor 130 may obtain information about at least one of components included in the host vehicle, a driving environment of the host vehicle, driving information of the host vehicle, or external information of the host vehicle, or any combination thereof.

For example, the sensor 130 may obtain sensor data. As an example, the sensor data may include sensor data obtained using light detection and ranging (LiDAR). As an example, the sensor data may include information about an external object which is present around the host vehicle.

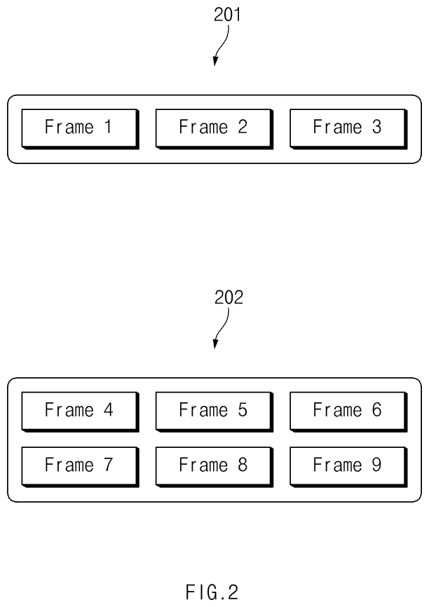

FIG. 2 shows an example of the result of classifying a plurality of frames into a plurality of bundles in a vehicle control apparatus according to an example of the present disclosure.

Referring to reference numerals 201 and 202, according to an example, a vehicle control apparatus (e.g., a vehicle control apparatus 100 of FIG. 1) may obtain a dataset including a plurality of frames using a sensor and may classify the dataset (or the plurality of frames) into at least one bundle.

Referring to reference numeral 201, according to an example, the vehicle control apparatus may classify frame 1, frame 2, and frame 3 among the plurality of frames into bundle 1. The frames included in bundle 1 may be defined as first frames.

Referring to reference numeral 202, according to an example, the vehicle control apparatus may classify frame 4, frame 5, frame 6, frame 7, frame 8, and frame 9 among the plurality of frames into bundle 2. The frames included in bundle 2 may be defined as second frames.

According to an example, the vehicle control apparatus may classify the dataset into a plurality of bundles, based on an acquisition time of each of the plurality of frames.

For example, if identifying that a time taken to obtain frame 4 elapses during a specified time (e.g., 30 minutes) from a time taken to obtain frame 3, the vehicle control apparatus may classify frames (e.g., frames 4 to 9) obtained subsequent to frame 3 into a bundle different from frame 3. The above-mentioned specified time may be defined as a criteria time for classifying the dataset into the plurality of bundles.

For example, the vehicle control apparatus may adjust the criteria time. For example, if the first condition described above in FIG. 1 is not met, the vehicle control apparatus may reduce the criteria time and may classify the dataset into the plurality of bundles again.

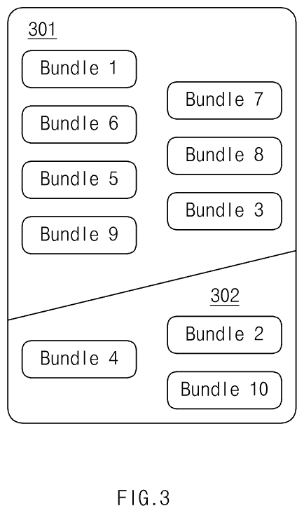

FIG. 3 shows an example of the result of dividing a plurality of bundles into training data or evaluation data in a vehicle control apparatus according to an example of the present disclosure.

According to an example, a vehicle control apparatus (e.g., a vehicle control apparatus 100 of FIG. 1) may classify a dataset into a plurality of bundles and may divide the plurality of classified bundles into different data (e.g., training data or evaluation data).

For example, the vehicle control apparatus may divide bundle 1, bundle 3, bundle 5, bundle 6, bundle 7, bundle 8, and bundle 9 into first data (e.g., training data). The first data may be stored in a learning DB 301.

For example, the vehicle control apparatus may divide bundle 2, bundle 4, and bundle 10 into second data (e.g., evaluation data). The second data may be stored in an evaluation DB 302. The evaluation DB 302 may be a separate DB implemented to differentiate from the learning DB 301 among a plurality of DBs included in a memory (e.g., a memory 110 of FIG. 1).

FIG. 4 shows an example of a plurality of division results of dividing a plurality of bundles in a vehicle control apparatus according to an example of the present disclosure.

According to an example, a vehicle control apparatus (e.g., a vehicle control apparatus 100 of FIG. 1) may identify a plurality of division results of dividing a plurality of bundles into training data 491 and evaluation data 492. Reference numerals 410, 420, and 430 shown in FIG. 4 may indicate conceptual diagrams according to the plurality of division results. For example, the vehicle control apparatus may determine whether each of the plurality of division results meets a first condition. If each of the plurality of division results does not meet the first condition, the vehicle control apparatus may classify a dataset into a plurality of bundles again and may determine whether the first condition is met.

Hereinafter, reference numerals for the plurality of bundles corresponding to each of reference numerals 410, 420, and 430 are defined to be different from each other to clarify the division, but bundle 1 411, bundle 1 421, and bundle 1 431 shown in reference numeral 410, reference numeral 420, and reference numeral 430 may be bundles which are the same as each other.

Referring to reference numeral 410, according to an example, the vehicle control apparatus may divide bundle 1 411 (or frames included in bundle 1 411) into the training data 491 and may divide the other bundles (e.g., bundle 2 412, bundle 3 413, . . . , bundle 9 419) into the evaluation data 492. For example, if the division result according to reference numeral 410 does not meet the first condition, the vehicle control apparatus may further check a division result according to reference numeral 420.

Referring to reference numeral 420, according to an example, the vehicle control apparatus may divide bundle 1 421 and bundle 2 422 (or frames included in bundle 1 421 and bundle 2 422) into the training data 491 and may divide the other bundles (e.g., bundle 3 423, . . . , bundle 9 429) into the evaluation data 492. For example, if the division result according to reference numeral 410 does not meet the first condition, the vehicle control apparatus may further check a division result according to reference numeral 430.

Referring to reference numeral 430, according to an example, the vehicle control apparatus may divide bundle 1 431, bundle 2 432, and bundle 3 433 (or frames included in bundle 1 431, bundle 2 432, and bundle 3 433) into the training data 491 and may divide the other bundles (e.g., bundle 4, . . . , bundle 9 439) into the evaluation data 492. For example, if the division result according to reference numeral 430 does not meet the first condition, the vehicle control apparatus may classify a dataset into a plurality of bundles again based on different criteria (e.g., criteria for reducing a criteria time) and may determine whether the first condition is met based on the classified result.

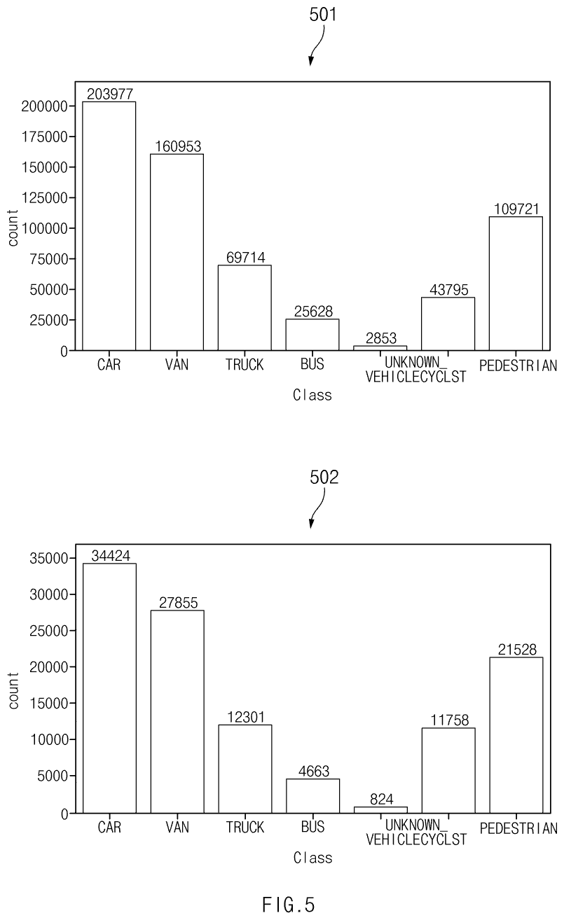

FIG. 5 shows an example of the number of objects included in training data and evaluation data according to an example of the present disclosure.

According to an example, a vehicle control apparatus (e.g., a vehicle control apparatus 100 of FIG. 1) may determine whether a second condition is met based on an inclusion percentage of an external object of each of frames included in different pieces of data.

For example, if a difference between a first inclusion percentage of each of external objects included in first frames in a first bundle divided into training data and a second inclusion percentage of each of the external objects included in second frames in a second bundle divided into evaluation data is less than or equal to a specified percentage, the vehicle control apparatus may determine that the second condition is met.

Reference numeral 501 is a chart for classifying an external object in frames included in training data, and reference numeral 502 is a chart for classifying an external object in frames included in evaluation data.

For example, the vehicle control apparatus may identify a percentage (or a ratio) of the number (203, 977) of cars in the number of all external objects in the training data as an inclusion percentage corresponding to the car in a first inclusion percentage.

For example, the vehicle control apparatus may identify a percentage (or a ratio) of the number (34,424) of cars in the number of all external objects in the evaluation data as an inclusion percentage corresponding to the car in a second inclusion percentage.

For example, if a difference between the inclusion percentages of the car in the training data and the evaluation data is less than or equal to a specified percentage, the vehicle control apparatus may similarly determine whether a difference between inclusion percentages for each of other external objects (e.g., a van, a truck, a bus, a cyclist, and a pedestrian) is less than or equal to the specified percentage.

If it is identified that a difference between the first inclusion percentage and the second inclusion percentage for all the external objects is less than or equal to the specified percentage, via the determination operation described above, the vehicle control apparatus may determine that the second condition is met.

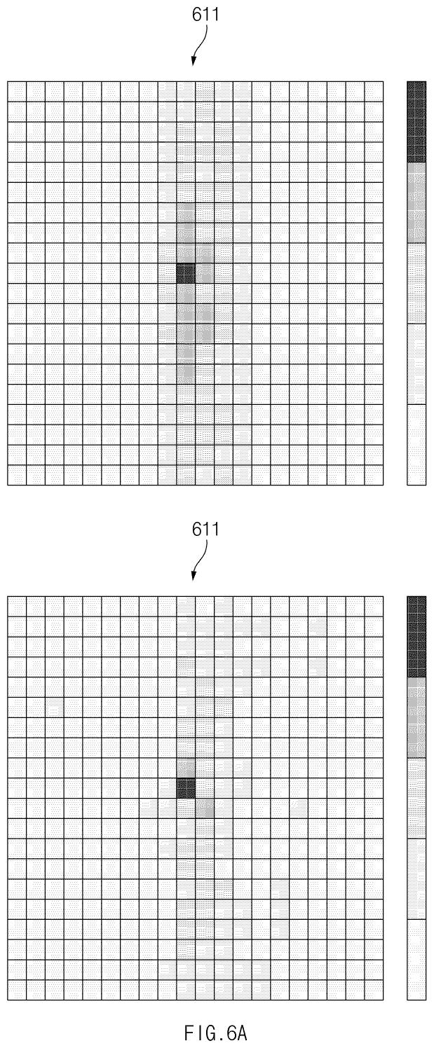

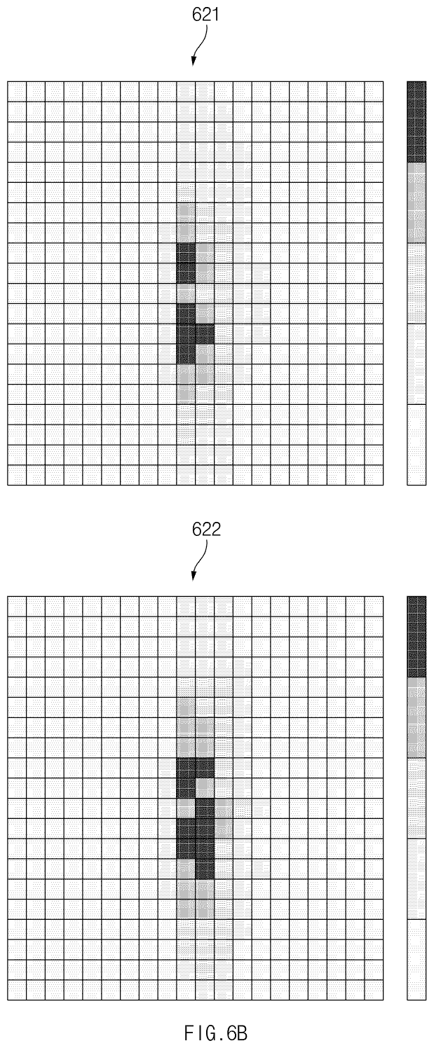

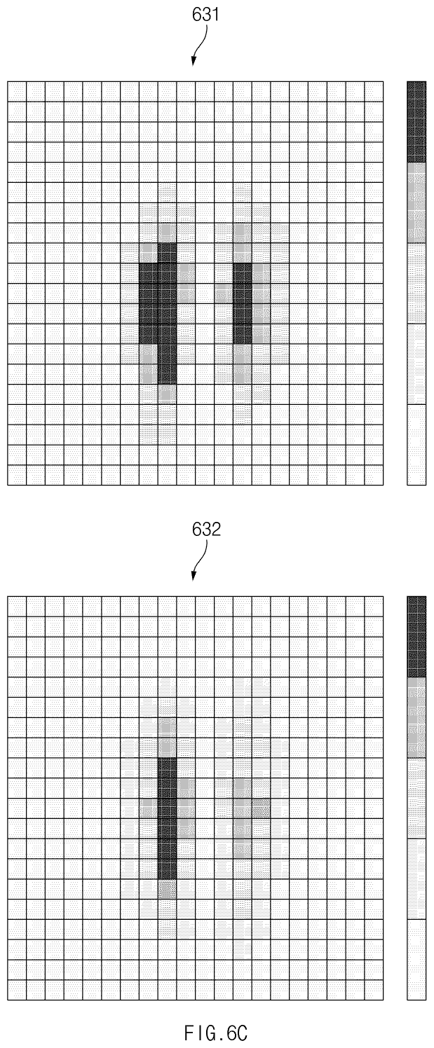

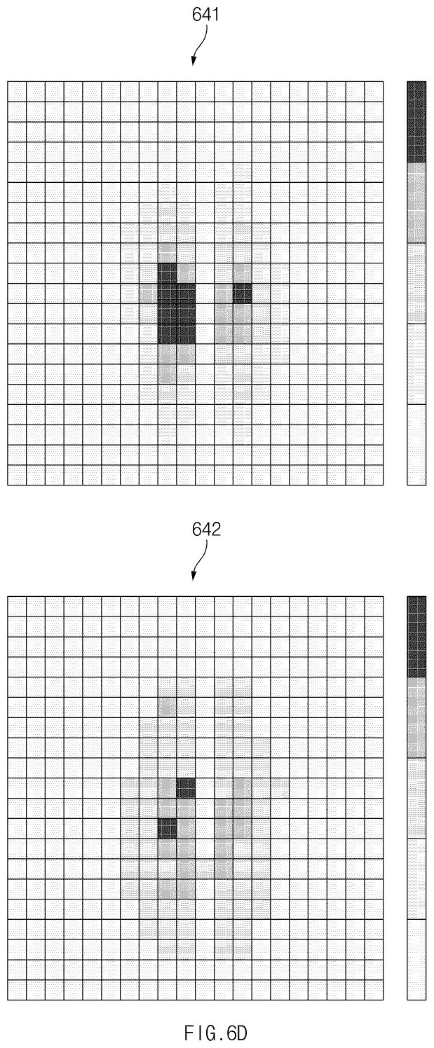

FIGS. 6A to 6D are graphs illustrating a specific object included in training data and evaluation data in a specified technique (e.g., a BEV) according to an example of the present disclosure.

Referring to FIG. 6A, according to an example, a vehicle control apparatus (e.g., a vehicle control apparatus 100 of FIG. 1) may calculate a standard deviation of a probability distribution for a first external object (e.g., a bus) in frames included in each of training data and evaluation data based on a BEV corresponding to the first external object.

For example, reference numeral 611 may be a BEV of the first external object in the training data, and reference numeral 612 may be a BEV of the first external object in the evaluation data.

Referring to FIG. 6B, according to an example, the vehicle control apparatus may calculate a standard deviation of a probability distribution for a second external object (e.g., a car) in frames included in each of the training data and the evaluation data based on a BEV corresponding to the second external object.

For example, reference numeral 621 may be a BEV of the second external object in the training data, and reference numeral 622 may be a BEV of the second external object in the evaluation data.

Referring to FIG. 6C, according to an example, the vehicle control apparatus may calculate a standard deviation of a probability distribution for a third external object (e.g., a pedestrian) in frames included in each of the training data and the evaluation data based on a BEV corresponding to the third external object.

For example, reference numeral 631 may be a BEV of the third external object in the training data, and reference numeral 632 may be a BEV of the third external object in the evaluation data.

Referring to FIG. 6D, according to an example, the vehicle control apparatus may calculate a standard deviation of a probability distribution for a fourth external object (e.g., a cyclist) in frames included in each of the training data and the evaluation data based on a BEV corresponding to the fourth external object.

For example, reference numeral 641 may be a BEV of the fourth external object in the training data, and reference numeral 642 may be a BEV of the fourth external object in the evaluation data.

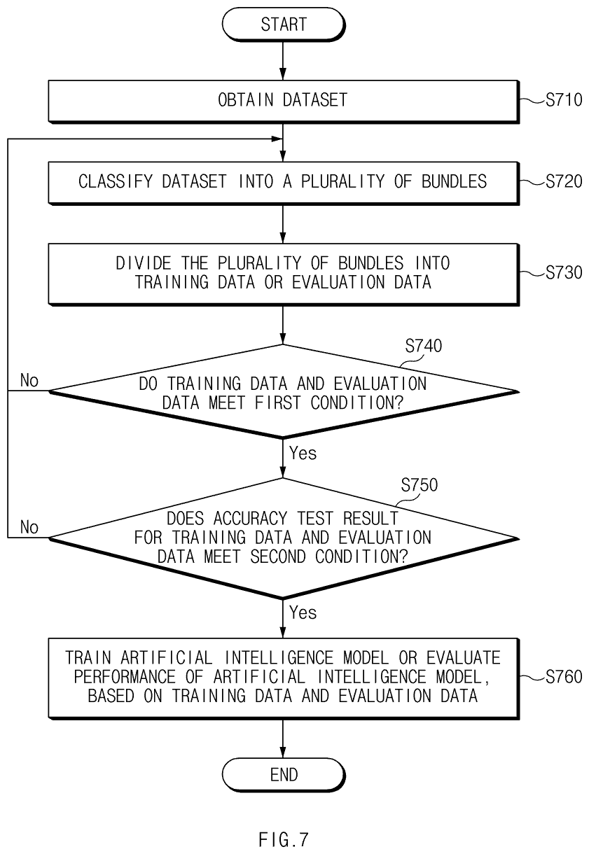

FIG. 7 shows an example of a vehicle control method according to an example of the present disclosure. For convenience, FIG. 7 may be described by way of an example in which the steps are performed by a processor (e.g., control circuitry). One, some, or all steps of FIG. 7, or portions thereof, may be performed by one or more other circuits. One or some, steps of FIG. 7 may be omitted, performed in other orders, and/or otherwise modified, and/or one or more additional steps may be added.

According to an example, a vehicle control apparatus (e.g., a vehicle control apparatus 100 of FIG. 1) may perform operations disclosed in FIG. 7. For example, at least some of components (e.g., a memory 110, a processor 120, and a sensor 130 of FIG. 1) included in the vehicle control apparatus may be configured to perform the operations of FIG. 7.

Operations in S710 to S760 in an example below may be sequentially performed, but are not necessarily sequentially performed. For example, an order of the respective operations may be changed, and at least two operations may be performed in parallel. Furthermore, contents, which correspond to or are duplicated with the contents described above in conjunction with FIG. 7, may be briefly described or omitted.

According to an example, in S710, the vehicle control apparatus may obtain a dataset.

For example, the vehicle control apparatus may obtain the dataset including a plurality of frames used for autonomous driving control of a host vehicle, using a sensor. As an example, the dataset may include sensor data obtained using LiDAR.

According to an example, in S720, the vehicle control apparatus may classify the dataset into a plurality of bundles.

For example, the vehicle control apparatus may classify the plurality of frames included in the dataset into different bundles.

According to an example, in S730, the vehicle control apparatus may divide the plurality of bundles into training data or evaluation data.

For example, the vehicle control apparatus may group the plurality of bundles into two groups and may identify the two groups as the training data and the evaluation data, respectively.

According to an example, in S740, the vehicle control apparatus may determine whether the training data and the evaluation data meet a first condition.

For example, if a ratio between the number of specified objects (e.g., cars) included in training data and the number of specified objects (e.g., cars) included in evaluation data is within a specified error range from a predefined ratio, the vehicle control apparatus may determine that the first condition is met.

For example, if the training data and the evaluation data meet the first condition (e.g., S740—Yes), the vehicle control apparatus may perform S750.

For example, if the training data and the evaluation data do not meet the first condition (e.g., S740—No), the vehicle control apparatus may repeatedly perform S720.

According to an example, in S750, the vehicle control apparatus may determine whether an accuracy test result for the training data and the evaluation data meets a second condition.

For example, the vehicle control apparatus may determine whether the second condition is met based on a scheme using an inclusion percentage of the external object of each of the training data and the evaluation data, a scheme using a difference between standard deviations of a probability distribution, and/or a scheme using criteria information.

For example, if the accuracy test result for the training data and the evaluation data meets the second condition (e.g., S750—Yes), the vehicle control apparatus may perform S760.

For example, if the accuracy test result for the training data and the evaluation data does not meet the second condition (e.g., S750—No), the vehicle control apparatus may repeatedly perform S720.

According to an example, in S760, the vehicle control apparatus may train an artificial intelligence model or may evaluate performance of the artificial intelligence model, based on the training data and the evaluation data.

For example, the vehicle control apparatus may train the artificial intelligence model, thus increasing object recognition performance of the artificial intelligence model.

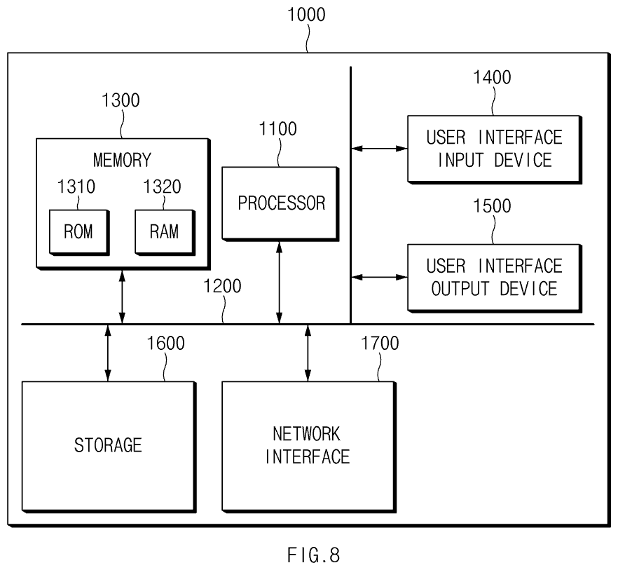

FIG. 8 shows an example of a computing system about a vehicle control method according to an example of the present disclosure.

Referring to FIG. 8, a computing system 1000 about the vehicle control method may include at least one processor 1100, a memory 1300, a user interface input device 1400, a user interface output device 1500, storage 1600, and a network interface 1700, which are connected with each other via a bus 1200.

The processor 1100 may be a central processing unit (CPU) or a semiconductor device that processes instructions stored in the memory 1300 and/or the storage 1600. The memory 1300 and the storage 1600 may include various types of volatile or non-volatile storage media. For example, the memory 1300 may include a ROM (Read Only Memory) 1310 and a RAM (Random Access Memory) 1320.

Accordingly, the operations of the method or algorithm described in connection with the examples disclosed in the specification may be directly implemented with a hardware module, a software module, or a combination of the hardware module and the software module, which is executed by the processor 1100. The software module may reside on a storage medium (that is, the memory 1300 and/or the storage 1600) such as a RAM, a flash memory, a ROM, an EPROM, an EEPROM, a register, a hard disc, a removable disk, and a CD-ROM.

The exemplary storage medium may be coupled to the processor 1100. The processor 1100 may read out information from the storage medium and may write information in the storage medium. Alternatively, the storage medium may be integrated with the processor 1100. The processor and the storage medium may reside in an application specific integrated circuit (ASIC). The ASIC may reside within a user terminal. In another case, the processor and the storage medium may reside in the user terminal as separate components.

The present disclosure has been made to solve the above-mentioned problems occurring in the prior art while advantages achieved by the prior art are maintained intact.

An example of the present disclosure provides a vehicle control apparatus for dividing a dataset into training data and evaluation data, which are at a specific ratio, depending on criteria defined by a user or a developer to increase the performance of an artificial intelligence model (or a deep learning network).

Another example of the present disclosure provides a vehicle control apparatus implemented to efficiently and quickly divide a dataset to minimize an unnecessary load and reduce resources and time.

The technical problems to be solved by the present disclosure are not limited to the aforementioned problems, and any other technical problems not mentioned herein will be clearly understood the following description by those skilled in the art to which the present disclosure pertains.

According to an example of the present disclosure, a vehicle control apparatus may include a memory storing at least one instruction and a processor operatively connected with the memory. For example, the at least one instruction may, when executed by the processor, cause the vehicle control apparatus to obtain a dataset including a plurality of frames for driving control for a host vehicle, classify the dataset into a plurality of bundles, divide the plurality of bundles into training data or evaluation data, perform an accuracy test for the training data and the evaluation data, if the training data and the evaluation data meet a first condition, and train an artificial intelligence model or evaluate performance of the artificial intelligence model, based on the training data and the evaluation data, if the result of performing the accuracy test meets a second condition.

According to an example, the vehicle control apparatus may further include a sensor. For example, the at least one instruction may, when executed by the processor, cause the vehicle control apparatus to input sensor data obtained using the sensor to the artificial intelligence model to detect an object which is present outside the host vehicle during the driving control.

According to an example, the plurality of frames may include at least one of a class of an external object, a location of the external object, a dimension of the external object, an acquisition period, a surrounding traffic environment, global positioning system (GPS) information, or weather information, or any combination thereof.

According to an example, the at least one instruction may, when executed by the processor, cause the vehicle control apparatus to identify the first number of specified objects included in first frames in a first bundle divided into the training data, identify the second number of the specified objects included in second frames in a second bundle divided into the evaluation data, and determine that the first condition is met, if a ratio between the first number and the second number is within a specified error range from a predefined ratio.

According to an example, the at least one instruction may, when executed by the processor, cause the vehicle control apparatus to obtain the plurality of frames using the sensor and classify the dataset into the plurality of bundles, based on an acquisition time of each of the plurality of frames.

According to an example, the at least one instruction may, when executed by the processor, cause the vehicle control apparatus to reduce a criteria time for classifying the dataset into the plurality of bundles and classify the dataset into the plurality of bundles again, if the first condition is not met.

According to an example, the at least one instruction may, when executed by the processor, cause the vehicle control apparatus to identify a plurality of division results of dividing the plurality of bundles into the training data and the evaluation data and classify the dataset into a different plurality of bundles again, f each of the plurality of division results does not meet the first condition.

According to an example, the at least one instruction may, when executed by the processor, cause the vehicle control apparatus to determine that the second condition is met, if a difference between a first inclusion percentage of each of external objects included in first frames in a first bundle divided into training data and a second inclusion percentage of each of the external objects included in second frames in a second bundle divided into evaluation data is less than or equal to a specified percentage.

According to an example, the at least one instruction may, when executed by the processor, cause the vehicle control apparatus to determine that the second condition is met, if a difference between a first standard deviation of a probability distribution for each of the external objects included in the first frames and a second standard deviation of the probability distribution for each of the external objects included in the second frames is less than or equal to a specified value.

According to an example, the at least one instruction may, when executed by the processor, cause the vehicle control apparatus to determine whether the second condition is met, based further on at least one of weather information of each of the training data and the evaluation data, traffic congestion of each of the training data and the evaluation data, GPS information of each of the training data and the evaluation data, or the number of vehicles per frame of each of the training data and the evaluation data, or any combination thereof.

According to another example of the present disclosure, a vehicle control apparatus may include obtaining, by a processor, a dataset including a plurality of frames for driving control host vehicle, classifying, by the processor, the dataset into a plurality of bundles, dividing, by the processor, the plurality of bundles into training data or evaluation data, performing, by the processor, an accuracy test for the training data and the evaluation data, if the training data and the evaluation data meet a first condition, and training, by the processor, an artificial intelligence model or evaluating, by the processor, performance of the artificial intelligence model, based on the training data and the evaluation data, if the result of performing the accuracy test meets a second condition.

According to an example, the vehicle control method may further include inputting, by the processor, sensor data obtained using a sensor to the artificial intelligence model to detect an object which is present outside the host vehicle during the driving control.

According to an example, the plurality of frames may include at least one of a class of an external object, a location of the external object, a dimension of the external object, an acquisition period, a surrounding traffic environment, GPS information, or weather information, or any combination thereof.

According to an example, the vehicle control method may further include identifying, by the processor, the first number of specified objects included in first frames in a first bundle divided into the training data, identifying, by the processor, the second number of the specified objects included in second frames in a second bundle divided into the evaluation data, and determining, by the processor, that the first condition is met, if a ratio between the first number and the second number is within a specified error range from a predefined ratio.

According to an example, the vehicle control method may further include obtaining, by the processor, the plurality of frames using the sensor and classifying, by the processor, the dataset into the plurality of bundles, based on an acquisition time of each of the plurality of frames.

According to an example, the vehicle control method may further include reducing, by the processor, a criteria time for classifying the dataset into the plurality of bundles and classifying, by the processor, the dataset into the plurality of bundles again, if the first condition is not met.

According to an example, the vehicle control method may further include identifying, by the processor, a plurality of division results of dividing the plurality of bundles into the training data and the evaluation data and classifying, by the processor, the dataset into a different plurality of bundles again, if each of the plurality of division results does not meet the first condition.

According to an example, the vehicle control method may further include determining, by the processor, that the second condition is met, if a difference between a first inclusion percentage of each of external objects included in first frames in a first bundle divided into the training data and a second inclusion percentage of each of the external objects included in second frames in a second bundle divided into the evaluation data is less than or equal to a specified percentage.

According to an example, the vehicle control method may further include determining, by the processor, that the second condition is met, if a difference between a first standard deviation of a probability distribution for each of the external objects included in the first frames and a second standard deviation of the probability distribution for each of the external objects included in the second frames is less than or equal to a specified value.

According to an example, the vehicle control method may further include determining, by the processor, whether the second condition is met, based further on at least one of weather information of each of the training data and the evaluation data, traffic congestion of each of the training data and the evaluation data, GPS information of each of the training data and the evaluation data, or the number of vehicles per frame of each of the training data and the evaluation data, or any combination thereof.

A description will be given of effects of the vehicle control apparatus and the method thereof according to an example of the present disclosure.

An example of the present disclosure may provide the vehicle control apparatus for dividing a dataset into training data and evaluation data, which are at a specific ratio, depending on criteria defined by a user or a developer to increase the performance of an artificial intelligence model (or a deep learning network).

An example of the present disclosure may provide the vehicle control apparatus implemented to efficiently and quickly divide a dataset to minimize an unnecessary load and reduce resources and time.

In addition, various effects ascertained directly or indirectly through the present disclosure may be provided.

Hereinabove, although the present disclosure has been described with reference to examples and the accompanying drawings, the present disclosure is not limited thereto, but may be variously modified and altered by those skilled in the art to which the present disclosure pertains without departing from the spirit and scope of the present disclosure claimed in the following claims.

Therefore, examples of the present disclosure are not intended to limit the technical spirit of the present disclosure, but provided only for the illustrative purpose. The scope of the present disclosure should be construed on the basis of the accompanying claims, and all the technical ideas within the scope equivalent to the claims should be included in the scope of the present disclosure.

What is claimed is:

1. An apparatus for controlling driving of a vehicle, the apparatus comprising:
a memory storing at least one instruction; and
a processor operatively coupled with the memory,
wherein the at least one instruction, when executed by the processor, is configured to cause the apparatus to:
obtain a dataset comprising a plurality of frames for driving control of the vehicle;
classify the dataset into a plurality of bundles;
divide the plurality of bundles into training data and evaluation data;
based on the training data and the evaluation data satisfying a first condition, perform an accuracy test for the training data and the evaluation data;
based on the accuracy test satisfying a second condition, train an artificial intelligence model or evaluate performance of the artificial intelligence model;
output a signal based on the trained artificial intelligence model or the evaluated performance of the artificial intelligence model; and
control, based on the signal, driving of the vehicle.

2. The apparatus of claim 1, further comprising:
a sensor,
wherein the at least one instruction, when executed by the processor, is configured to cause the apparatus to:
input sensor data obtained using the sensor to the artificial intelligence model to detect an object which is present outside the vehicle during the driving control.

3. The apparatus of claim 1, wherein the plurality of frames comprise at least one of:
a class of an external object,
a location of the external object,
a dimension of the external object,
an acquisition period, wherein the acquisition period corresponds to a duration of time over which data is collected for frames within a bundle,
surrounding traffic environment information,
global positioning system (GPS) information, or
weather information.

4. The apparatus of claim 1, wherein the at least one instruction, when executed by the processor, is configured to cause the apparatus to:
identify a first number of specified objects included in first frames, wherein the first frames are within a first bundle of the plurality of bundles divided into the training data;
identify a second number of the specified objects included in second frames, wherein the second frames are within a second bundle of the plurality of bundles divided into the evaluation data; and
determine that the first condition is satisfied based on a ratio between the first number and the second number being within a specified error range from a predefined ratio.

5. The apparatus of claim 2, wherein the at least one instruction, when executed by the processor, is configured to cause the apparatus to:
obtain the plurality of frames using the sensor; and
classify, based on an acquisition time of each of the plurality of frames, the dataset into the plurality of bundles.

6. The apparatus of claim 5, wherein the at least one instruction, when executed by the processor, is configured to cause the apparatus to:
based on the first condition not being satisfied, reduce a criteria time for classifying the dataset into the plurality of bundles and classify the dataset into the plurality of bundles again.

7. The apparatus of claim 1, wherein the at least one instruction, when executed by the processor, is configured to cause the apparatus to:
identify a plurality of division results of dividing the plurality of bundles into the training data and the evaluation data; and
based on each of the plurality of division results not satisfying the first condition, classify the dataset into a different plurality of bundles again.

8. The apparatus of claim 1, wherein the at least one instruction, when executed by the processor, is configured to cause the apparatus to:
based on a difference between a first inclusion percentage and a second inclusion percentage being less than or equal to a specified percentage, determine that the second condition is satisfied, wherein:
the first inclusion percentage corresponds to a proportion of first frames that include each of external objects,
wherein the first frames are within a first bundle of the plurality of bundles divided into the training data, and
the second inclusion percentage corresponds to a proportion of second frames that include each of the external objects, wherein the second frames are within a second bundle of the plurality of bundles divided into evaluation data.

9. The apparatus of claim 8, wherein the at least one instruction, when executed by the processor, is configured to cause the apparatus to:
based on a difference between a first standard deviation and a second standard deviation being less than or equal to a specified value, determine that the second condition is satisfied, wherein:
the first standard deviation corresponds to a standard deviation of a probability distribution for each of the external objects included in the first frames, and
the second standard deviation corresponds to a standard deviation of a probability distribution for each of the external objects included in the second frames.

10. The apparatus of claim 8, wherein the at least one instruction, when executed by the processor, is configured to cause the apparatus to:
determine whether the second condition is satisfied, further based on at least one of:
weather information of each of the training data and the evaluation data,
traffic congestion of each of the training data and the evaluation data,
global positioning system (GPS) information of each of the training data and the evaluation data, or
a number of vehicles per frame of each of the training data and the evaluation data.

11. A method performed by an apparatus for controlling driving of a vehicle, the method comprising:
obtaining a dataset comprising a plurality of frames for driving control of the vehicle;
classifying the dataset into a plurality of bundles;
dividing the plurality of bundles into training data and evaluation data;
based on the training data and the evaluation data satisfying a first condition, performing an accuracy test for the training data and the evaluation data;
based on the accuracy test satisfying a second condition, training an artificial intelligence evaluating performance of the artificial intelligence model;
outputting a signal based on the trained artificial intelligence model or the evaluated performance of the artificial intelligence model; and
controlling, based on the signal, driving of the vehicle.

12. The method of claim 11, further comprising:
inputting sensor data obtained using a sensor of the vehicle to the artificial intelligence model to detect an object which is present outside the vehicle during the driving control.

13. The method of claim 11, wherein the plurality of frames comprise at least one of:
a class of an external object,
a location of the external object,
a dimension of the external object,
an acquisition period, wherein the acquisition period corresponds to a duration of time over which data is collected for frames within a bundle,
surrounding traffic environment information,
global positioning system (GPS) information, or
weather information.

14. The method of claim 11, further comprising:
identifying a first number of specified objects included in first frames, wherein the first frames are within a first bundle of the plurality of bundles divided into the training data;
identifying a second number of the specified objects included in second frames, wherein the second frames are within a second bundle of the plurality of bundles divided into the evaluation data; and
determining that the first condition is satisfied based on a ratio between the first number and the second number being within a specified error range from a predefined ratio.

15. The method of claim 12, further comprising:
obtaining the plurality of frames using the sensor; and
classifying, based on an acquisition time of each of the plurality of frames, the dataset into the plurality of bundles.

16. The method of claim 15, further comprising:
based on the first condition not being satisfied, reducing a criteria time for classifying the dataset into the plurality of bundles and classifying the dataset into the plurality of bundles again.

17. The method of claim 11, further comprising:
identifying a plurality of division results of dividing the plurality of bundles into the training data and the evaluation data; and
based on each of the plurality of division results not satisfying the first condition, classifying the dataset into a different plurality of bundles again.

18. The method of claim 11, further comprising:
based on a difference between a first inclusion percentage and a second inclusion percentage being less than or equal to a specified percentage, determining that the second condition is satisfied, wherein:
the first inclusion percentage corresponds to a proportion of first frames that include each of external objects,
wherein the first frames are within a first bundle of the plurality of bundles divided into the training data, and
the second inclusion percentage corresponds to a proportion of second frames that include each of the external objects, wherein the second frames are within a second bundle of the plurality of bundles divided into evaluation data.

19. The method of claim 18, further comprising:
based on a difference between a first standard deviation and a second standard deviation being less than or equal to a specified value, determining that the second condition is satisfied, wherein:
the first standard deviation corresponds to a standard deviation of a probability distribution for each of the external objects included in the first frames, and
the second standard deviation corresponds to a standard deviation of the probability distribution for each of the external objects included in the second frames.

20. The method of claim 18, further comprising:
determining whether the second condition is satisfied, further based on at least one of:
weather information of each of the training data and the evaluation data,
traffic congestion of each of the training data and the evaluation data,
global positioning system (GPS) information of each of the training data and the evaluation data, or
a number of vehicles per frame of each of the training data and the evaluation data.
